(19) United States
(12) Patent Application Publication
(10) Pub. No.: US 2023/0193071 A1
(43) Pub. Date: Jun. 22, 2023

(54) SURFACE TREATMENT AGENT FOR ORGANIC-INORGANIC HYBRID COMPOSITION

(71) Applicant: KCTECH CO., LTD., Gyeonggi-do (KR)

(72) Inventors: Jin Seok YEOM, Gyeonggi-do (KR); Seok Jo KIM, Chungcheongnam-do (KR)

(73) Assignee: KCTECH CO., LTD., Gyeonggi-do (KR)

(21) Appl. No.: 18/079,883

(22) Filed: Dec. 13, 2022

(30) Foreign Application Priority Data
Dec. 20, 2021 (KR) 10-2021-0182889

(51) Int. Cl. C09D 143/04; C09D 7/61; C09D 7/20

(52) U.S. Cl. CPC C09D 143/04; C09D 7/61; C09D 7/20

(57) ABSTRACT

A surface treatment agent for an organic-inorganic hybrid composition is provided. The surface treatment agent includes a compound represented by one of the following Chemical Formulae 1 to 3.

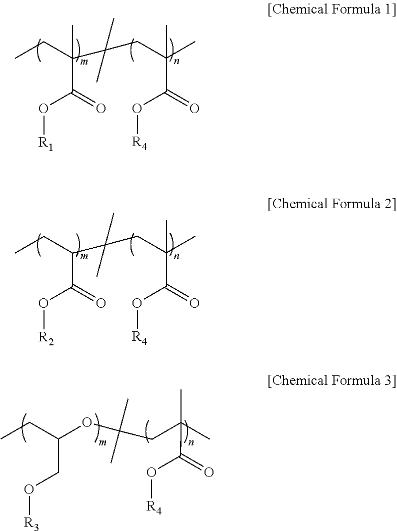

In Chemical Formulae 1 to 3, R₁ to R₃ each include at least one of hydrogen (H), a saturated or unsaturated linear or branched C₁ to C₂₀ alkyl group, a silane group, a hydroxyl group, and an alkoxysilane group, and R₄ includes H or a hydroxyl group.

### CROSS-REFERENCE TO RELATED APPLICATION

This application claims the benefit of Korean Patent Application No. 10-2021-0182889 filed on Dec. 20, 2021, in the Korean Intellectual Property Office, the entire disclosure of which is incorporated herein by reference for all purposes.

### BACKGROUND

### 1. Field of the Invention

One or more embodiments relate to a surface treatment agent for an organic-inorganic hybrid composition.

### 2. Description of the Related Art

An optically clear adhesive (OCA) film is a transparent adhesive film used for bonding an optical member. Recently, the demand for touch panels in the fields of smartphones, tablet personal computers (PCs), portable game consoles, automobile navigation devices, and the like is rapidly increasing, and the demand for OCA films used to bond a touch panel to other optical members is also rapidly increasing.

A display device with a touch panel typically has a structure in which a display panel such as a liquid crystal panel, a touch panel body, which includes a transparent conductive film formed of indium tin oxide (ITO) on a surface layer, and an optical member such as a cover panel for protecting the transparent conductive film are laminated. An optically transparent adhesive may be used in the form of a film for bonding between optical members. As the demand for OCA films increases, an interest in adhesive materials used therein is further increasing.

Existing optically transparent adhesives are formed of organic materials, such as silicone-based resins, polyurethane-based resins, or olefin-based resins. If such organic material-based optically transparent adhesives are used for display optical materials, an issue of having an influence on optical properties due to a difference in a refractive index between laminated layers may occur.

To overcome such a phenomenon, technology for increasing a refractive index by mixing inorganic particles with an organic material-based optically transparent adhesive has been developed. However, when organic materials and inorganic particles are mixed, an issue of compatibility may occur.

The above description is information the inventor(s) acquired during the course of conceiving the present disclosure, or already possessed at the time, and was not necessarily publicly known before the present application was filed.

### SUMMARY

To solve the above issues, one or more embodiments of the present disclosure provide a surface treatment agent for an organic-inorganic hybrid composition.

According to an embodiment, an organic-inorganic hybrid composition may be provided.

However, goals to be achieved are not limited to those described above, and other goals not mentioned above are clearly understood by one of ordinary skill in the art from the following description.

According to an aspect, there is provided a surface treatment agent for an organic-inorganic hybrid composition. The surface treatment agent may include a compound represented by one of Chemical Formulae 1 to 3 shown below.

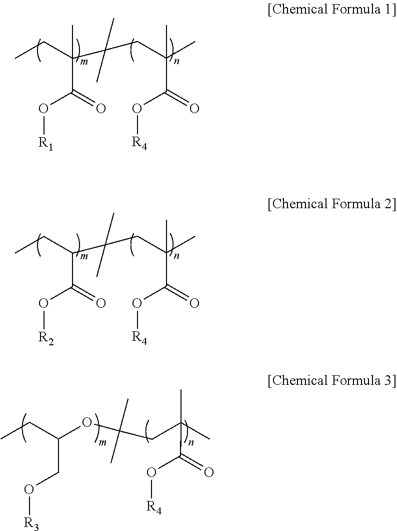

In Chemical Formulae 1 to 3, R₁ to R₃ each include at least one of hydrogen (H), a saturated or unsaturated linear or branched C₁ to C₂₀ alkyl group, a silane group, a hydroxyl group, and an alkoxysilane group, and R₄ includes H or a hydroxyl group.

According to an embodiment, R₁ to R₃ may each include at least one selected from a group consisting of a C₂ to C₁₂ alkyltrimethoxy silane group, a C₂ to C₁₂ alkyltriethoxy silane group, and a C₂ to C₁₂ alkyldimethoxyethoxy silane group.

According to an embodiment, R₄ may include at least one of H, a 2-hydroxyethyl group, a 3-hydroxypropyl group, and a 2-hydroxybutyl group.

According to an embodiment, an integer ratio between m and n may be in a range of 1:2 to 2:1.

According to an embodiment, the surface treatment agent may further include a polymerization initiator including at least one of benzoyl peroxide (BPO), azobisisobutyronitrile (AIBN), and 2,2′-azobis(2-methylpropionamidine)dihydrochloride (AIBA).

According to an embodiment, the polymerization initiator may be in an amount of 0.1% by weight (wt %) to 1 wt % in the surface treatment agent.

According to an embodiment, a light transmittance of the surface treatment agent may be greater than or equal to 40%.

According to an embodiment, a haze value of the surface treatment agent may be less than or equal to 80%.

Additional aspects of example embodiments will be set forth in part in the description which follows and, in part, will be apparent from the description, or may be learned by practice of the disclosure.

According to embodiments, a surface treatment agent for an organic-inorganic hybrid composition may be provided.

According to embodiments, an organic-inorganic hybrid composition may be provided.

### DETAILED DESCRIPTION

Hereinafter, embodiments will be described in detail. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or greater other features, integers, steps, operations, elements, components and/or groups thereof.

Unless otherwise defined, all terms including technical and scientific terms used herein have the same meaning as commonly understood by one of ordinary skill in the art to which embodiments belong. Terms defined in dictionaries generally used should be construed to have meanings matching with contextual meanings in the related art and are not to be construed as an ideal or excessively formal meaning unless otherwise defined herein.

In addition, the terms such as first, second, A, B, (a), (b) or the like may be used to describe components of the embodiments. Each of these terms is not used to define an essence, order or sequence of a corresponding component but used merely to distinguish the corresponding component from other component(s). It should be noted that if it is described in the specification that one component is “connected”, “coupled”, or “joined” to another component, the former may be directly “connected,” “coupled,” and “joined” to the latter or “connected”, “coupled”, and “joined” to the latter via another component.

Components included in one embodiment and components having a common function will be described using the same names in other embodiments. Unless otherwise mentioned, the descriptions of the embodiments may be applicable to the following embodiments and thus, duplicated descriptions will be omitted for conciseness.

An organic-inorganic hybrid composition according to an embodiment may include inorganic particles with surfaces modified by a surface treatment agent, and an acrylic monomer. According to an embodiment, the organic-inorganic hybrid composition may be cured to form an adhesive film. According to embodiments of the present disclosure, the organic-inorganic hybrid composition may provide an optically transparent or substantially optically transparent inorganic particle dispersion composition.

According to an embodiment, to improve a dispersibility of the inorganic particles, the surfaces of the inorganic particles may be modified using the surface treatment agent. If the inorganic particles are evenly dispersed in the organic-inorganic hybrid composition, an optically transparent inorganic particle dispersion composition may be provided.

According to an embodiment, a weight ratio between the surface-modified inorganic particles and the acrylic monomer may be in a range of 1:1 to 2:1. According to an embodiment, a weight of the acrylic monomer may desirably be greater than or equal to a weight of the surface-modified inorganic particles.

According to an embodiment, the inorganic particles may be metal oxides.

According to an embodiment, the inorganic particles, which are metal oxides, may be included in a transparent polymer resin to increase a refractive index.

According to an embodiment, the inorganic particles may include at least one of ZrO₂, SiO₂, Al₂O₃, CeO₂, ZnO, V₂O₅TiO₂, BaTiO₃, SrTiO₃, BaTiO₃, PbTiO₃, PbZrO₃, Pb(Zr,Ti)O₃ (PZT), Pb₁₋ₓLaₓZr_{1-y}Ti_{y}O₃(PLZT), (1-x)Pb(Mg_{1/3}Nb_{2/3})O₃-xPbTiO₃ (PMN-PT), HfO₂, and BN.

According to an embodiment, the inorganic particles may desirably include zirconia (ZrO₂). Zirconia may be transparent, may have a high Abbe number, and may be excellent in a mechanical strength and a thermal stability. Thus, zirconia may be suitable for the organic-inorganic hybrid composition according to an embodiment.

According to an embodiment, the inorganic particles may correspond to inorganic nanoparticles. According to an embodiment, the inorganic particles may have a diameter of 10 nanometers (nm) to 200 nm. Here, the diameter of the inorganic particles may refer to an average of diameters of the inorganic particles. In addition, the diameter of the inorganic particles may refer to a diameter of an inorganic particle having a surface that is not modified with the surface treatment agent.

According to an embodiment, the diameter of the inorganic particles may be 10 nm or greater, 20 nm or greater, 30 nm or greater, 40 nm or greater, 50 nm or greater, 60 nm or greater, 70 nm or greater, 80 nm or greater, 90 nm or greater, 100 nm or greater, 110 nm or greater, 120 nm or greater, 130 nm or greater, 140 nm or greater, 150 nm or greater, 160 nm or greater, 170 nm or greater, 180 nm or greater, or 190 nm or greater; 200 nm or less, 190 nm or less, 180 nm or less, 170 nm or less, 160 nm or less, 150 nm or less, 140 nm or less, 130 nm or less, 120 nm or less, 110 nm or less, 100 nm or less, 90 nm or less, 80 nm or less, 70 nm or less, or 60 nm or less; or may be included in a range between two values selected from the aforementioned values.

According to an embodiment, when the diameter of the inorganic particles is less than 10 nm, it may be difficult to disperse the inorganic particles due to an increase in surface energy of the inorganic particles. When the diameter of the inorganic particles exceeds 200 nm, a scattering effect may be expressed, which may lead to a reduction in a visibility of an adhesive film and an increase in a thickness of the adhesive film.

According to an embodiment, a specific surface area of the inorganic particles may be in a range of 1 m²/g to 250 m²/g. Here, the specific surface area of the inorganic particles may refer to an average of specific surface areas of the inorganic particles. In addition, the specific surface area of the inorganic particles may include a specific surface area of an inorganic particle having a surface that is not modified with the surface treatment agent.

According to an embodiment, the specific surface area of the inorganic particles may be 1 m²/g or greater, 10 m²/g or greater, 30 m²/g or greater, 50 m²/g or greater, 70 m²/g or greater, 90 m²/g or greater, 110 m²/g or greater, 130 m²/g or greater, 150 m²/g or greater, 170 m²/g or greater, 190 m²/g or greater, 210 m²/g or greater, or 230 m²/g or greater; 250 m²/g or less, 230 m²/g or less, 210 m²/g or less, 190 m²/g or less, 170 m²/g or less, 150 m²/g or less, 130 m²/g or less, 110 m²/g or less, 90 m²/g or less, or 70 m²/g or less; or may be included in a range between two values selected from the aforementioned values.

According to an embodiment, when the specific surface area of the inorganic particles is out of the above ranges, a transmittance may be reduced, or a quality may be reduced due to scattering, and an agglomeration may be formed.

According to an embodiment, the surface-modified inorganic particles may be in an amount of 40% by weight (wt %) to 50 wt % in the organic-inorganic hybrid composition. According to an embodiment, the surface-modified inorganic particles may be in an amount of 40 wt % to 45 wt %, or an amount of 45 wt % to 50 wt % in the organic-inorganic hybrid composition.

According to an embodiment, when the amount of the surface-modified inorganic particles in the organic-inorganic hybrid composition is less than 40 wt %, the refractive index and luminance of the organic-inorganic hybrid composition may be reduced due to a decrease in a relative ratio of the inorganic particles in the organic-inorganic hybrid composition. When the amount of the surface-modified inorganic particles in the organic-inorganic hybrid composition exceeds 50 wt %, a cloudiness phenomenon may occur during preparing of an adhesive film. According to an embodiment, the acrylic monomer may include at least one of butyl acrylate, 2-ethylhexyl acrylate, isobornyl acrylate, and 4-acryloyl morpholine.

An adhesive film may be prepared by curing the organic-inorganic hybrid composition according to an embodiment. By applying an acrylic monomer, a flexible and optically excellent adhesive film may be prepared.

According to an embodiment, the acrylic monomer may be in an amount of 50 wt % to 60 wt % in the organic-inorganic hybrid composition. According to an embodiment, the acrylic monomer may be in an amount of 50 wt % to 55 wt %, or an amount of 55 wt % to 60 wt % in the organic-inorganic hybrid composition.

According to an embodiment, when the amount of the acrylic monomer in the organic-inorganic hybrid composition is less than 50 wt %, a proportion of the inorganic particles may increase, which may lead to an increase in the viscosity. When the amount of the acrylic monomer in the organic-inorganic hybrid composition exceeds 60 wt %, the proportion of the inorganic particles may be lowered, and a refractive index and a luminance of the adhesive film may be reduced, and accordingly a cloudiness phenomenon may occur.

According to an embodiment, the surface treatment agent may be a copolymer of a silane-based monomer and a methacrylate-based monomer. For example, the surface treatment agent may be a random copolymer of a silane-based monomer and a methacrylate-based monomer.

According to an embodiment, the silane-based monomer may include at least one of silane, C₁-C₂₀ alkyl silane, alkoxy silane, isocyanate silane, amino silane, epoxy silane, acryl silane, mercapto silane, fluorosilane, methacryloxy silane, vinyl silane, phenyl silane, chloro silane, and silazane.

For example, the silane-based monomer may include at least one of a vinyl group-containing silane-based monomer including at least one of vinyltrimethoxysilane, vinyltriethoxysilane, and vinyltris(2-methoxyethoxy)silane; a methacryloxy group-containing silane-based monomer including at least one of 3-methacryloxypropyltrimethoxysilane (MPTMS), 3-methacryloxypropyltriethoxysilane (MPTES), 3-methacryloxypropylmethyldimethoxysilane, and 3-methacryloxypropylmethyldiethoxysilane; an acetoxy group-containing silane-based monomer including vinyltriacetoxysilane; an acryloxy group-containing silane-based monomer including 3-acryloxypropyltrimethoxysilane (APTMS), 3-acryloxypropyltriethoxysilane, or both; an epoxy group-containing silane-based monomer including at least one of 3-glycidoxypropyltrimethoxysilane (GPTMS), 3-glycidoxypropyltriethoxysilane (GPTES), 3-glycidoxypropylmethyldimethoxysilane, 3-glycidoxypropylmethyldiethoxysilane, and 2-(3,4-epoxycyclohexyl)ethyltrimethoxysilane; a chloro group-containing silane-based monomer including vinyltrichlorosilane; a mercapto group-containing silane-based monomer including at least one of 3-mercaptopropyltrimethoxysilane, 3-mercaptopropyltriethoxysilane, 3-mercaptopropylmethyldimethoxysilane, and 3-mercaptopropylmethyldiethoxysilane; an anhydride group-containing silane-based monomer including 3-trimethoxysilylpropyl succinic anhydride, and 3-triethoxysilylpropyl succinic anhydride; an amino group-containing silane-based monomer including at least one of 3-aminopropyltrimethoxysilane, 3-aminopropyltriethoxysilane, and N-2-(aminoethyl)-3-aminopropyltrimethoxysilane; and an isocyanate group-containing silane-based monomer including 3-isocyanatopropyltrimethoxysilane, 3-isocyanatopropyltriethoxysilane, or both. According to an embodiment, the silane-based monomer may be a silane coupling agent.

According to an embodiment, the methacrylate-based monomer may include at least one of 2-hydroxyethyl methacrylate (2-HEMA), 2-hydroxypropyl methacrylate (2-HPMA), and 2-hydroxy-1-methylethyl methacrylate.

According to an embodiment, the surface treatment agent may include a compound represented by one of Chemical Formulae 1 to 3 shown below.

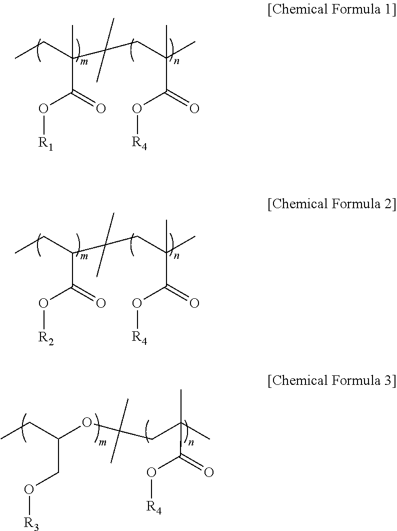

In Chemical Formulae 1 to 3, R₁ to R₃ may each include at least one of hydrogen (H), a saturated or unsaturated linear or branched C₁ to C₂₀ alkyl group, a silane group, a hydroxyl group, and an alkoxysilane group, and R₄ may include H or a hydroxyl group.

For example, R₁ to R₃ may each include at least one of a C₂ to C₁₂ alkyltrimethoxy silane group, a C₂ to C₁₂ alkyltriethoxy silane group, and a C₂ to C₁₂ alkyldimethoxyethoxy silane group. For example, R₁ to R₃ may each include at least one of an ethyltrimethoxysilane group, a propyltrimethoxysilane group, a butyltrimethoxysilane group, a pentyltrimethoxysilane group, a hexyltrimethoxysilane group, a heptyltrimethoxysilane group, an octyltrimethoxysilane group, a nonyltrimethoxysilane group, decyltrimethoxysilane group, a undecyltrimethoxysilane group, dodecyltrimethoxysilane group, an ethyltriethoxysilane group, a propyltriethoxysilane group, a butyltriethoxysilane group, a pentyltriethoxysilane group, a hexyltriethoxysilane group, a heptyltriethoxysilane group, an octyltriethoxysilane group, a nonyltriethoxysilane group, a decyltriethoxysilane group, a undecyltriethoxysilane group, dodecyltriethoxysilane group, an ethyldimethoxyethoxysilane group, a propyldimethoxyethoxysilane group, a butyldimethoxyethoxysilane group, a pentyldimethoxyethoxysilane group, a hexyldimethoxyethoxysilane group, a heptyldimethoxyethoxysilane group, an octyldimethoxyethoxysilane group, a nonyldimethoxyethoxysilane group, a decyldimethoxyethoxysilane group, a undecyldimethoxyethoxysilane group, and a dodecyldimethoxyethoxysilane group.

According to an embodiment, in R₄, H or a hydroxyl group may be formed at an opposite end of a portion connected to a methacryl group. For example, R₄ may include at least one of a 2-hydroxyethyl group, a 3-hydroxypropyl group, and a 2-hydroxybutyl group.

According to an embodiment, the surface treatment agent may be a copolymer of two different methacrylate-based monomers, a copolymer of an acrylate-based monomer and a methacrylate-based monomer, or a copolymer of an epoxy-based monomer and a methacrylate-based monomer.

According to an embodiment, properties of the surface treatment agent for the organic-inorganic hybrid composition including the compound represented by one of Chemical Formulae 1 to 3 may be determined according to a ratio between m and n. According to an embodiment, an integer ratio between m and n may be in a range of 1:2 to 2:1. For example, the integer ratio between m and n may be in a range of 1:1, 3:2, 2:3, 4:3, 5:3, 3:4, 5:4, or 7:4.

According to an embodiment, the surface treatment agent may be included in an amount of 10 parts by weight to 30 parts by weight with respect to 100 parts by weight of the inorganic particles. According to an embodiment, when the amount of the surface treatment agent is less than 10 parts by weight with respect to 100 parts by weight of the inorganic particles, a dispersibility may be reduced. When the amount of the surface treatment agent exceeds 30 parts by weight, curing may be difficult during preparing of a film.

According to an embodiment, the surface treatment agent may include a polymerization initiator among at least one of benzoyl peroxide (BPO), azobisisobutyronitrile (AIBN), and 2,2′-azobis(2-methylpropionamidine)dihydrochloride (AIBA). According to an embodiment, the polymerization initiator may include a peroxide-based compound, an azo compound, or both.

According to an embodiment, the polymerization initiator may be in an amount of 0.1 wt % to 1 wt % in the surface treatment agent. According to an embodiment, when the amount of the polymerization initiator is less than 0.1 wt %, only a portion of a copolymerization may be performed. When the amount of the polymerization initiator exceeds 1 wt %, an excess polymerization initiator may be left in the surface treatment agent and function as impurities.

According to an embodiment, a light transmittance of the surface treatment agent may be greater than or equal to 40%.

According to an embodiment, the light transmittance of the surface treatment agent may be 40% or greater, 42% or greater, 45% or greater, or 50% or greater.

According to an embodiment, a haze value of the surface treatment agent may be less than or equal to 80%.

According to an embodiment, the haze value of the surface treatment agent may be 80% or less, 70% or less, 60% or less, or 50% or less.

According to an embodiment, the organic-inorganic hybrid composition may further include a dispersant (or dispersing agent) including at least one functional group among a carboxyl group, a phosphoric acid group, a phosphonic acid group, a sulfonic acid group, and a phenolic hydroxyl group. According to an embodiment, the dispersant may desirably include a carboxyl group.

According to an embodiment, the dispersant may be available from commercial products. According to an embodiment, the dispersant may be a dispersant under the following trade names, and may include at least one of DISPERBYK, DISPERBYK-101, DISPERBYK-102, DISPERBYK-103, DISPERBYK-106, DISPERBYK-107, DISPERBYK-108, DISPERBYK-109, DISPERBYK-110, DISPERBYK-111, DISPERBYK-112, DISPERBYK-115, DISPERBYK-116, DISPERBYK-118, DISPERBYK-130, DISPERBYK-140, DISPERBYK-142, DISPERBYK-145, DISPERBYK-160, DISPERBYK-161, DISPERBYK-162, DISPERBYK-163, DISPERBYK-164, DISPERBYK-165, DISPERBYK-166, DISPERBYK-167, DISPERBYK-168, DISPERBYK-169, DISPERBYK-170, DISPERBYK-171, DISPERBYK-174, DISPERBYK-176, DISPERBYK-180, DISPERBYK-181, DISPERBYK-182, DISPERBYK-183, DISPERBYK-184, DISPERBYK-185, DISPERBYK-187, DISPERBYK-190, DISPERBYK-191, DISPERBYK-192, DISPERBYK-193, DISPERBYK-194, DISPERBYK-2000, DISPERBYK-2001, DISPERBYK-2008, DISPERBYK-2009, DISPERBYK-2010, DISPERBYK-2020, DISPERBYK-2025, DISPERBYK-2050, DISPERBYK-2070, DISPERBYK-2090, DISPERBYK-2091, DISPERBYK-2095, DISPERBYK-2096, DISPERBYK-2150, DISPERBYK-2151, DISPERBYK-2152, DISPERBYK-2155, DISPERBYK-2163, and DISPERBYK-2164. In addition, according to an embodiment, in addition to the trade names, the dispersant may include at least one of Antiterra-U, P104, Disperbyk 110, Disperbyk 130, Disperbyk 160, Disperbyk 170 Family, EFKA 776, EFKA 4050, EFKA 4063, EFKA 4051, Solsperse 24000, Solsperse 36600, Solsperse 32600, Solsperse 22000, and Solsperse 5000.

According to an embodiment, the dispersant may be included in an amount of 1 to 10 parts by weight based on 100 parts by weight of the organic-inorganic hybrid composition. According to an embodiment, the dispersant may be included in an amount of 1 part by weight to 5 parts by weight, or an amount of 3 parts by weight to 7 parts by weight, based on 100 parts by weight of the organic-inorganic hybrid composition.

According to an embodiment, the organic-inorganic hybrid composition may further include a dispersion solvent. The dispersion solvent may include at least one of methyl ethyl ketone (MEK), ethanol, methanol, acetonitrile, toluene, tetrahydrofuran (THF), propylene glycol monomethyl ether acetate (PGMEA), and ethyl acetate.

According to an embodiment, a weight of the dispersion solvent may be greater than or equal to the weight of the surface-modified inorganic particles. According to an embodiment, a weight ratio between the surface-modified inorganic particles and the dispersion solvent may be in a range of 1:1 to 1:2.

According to an embodiment, the dispersion solvent may be in an amount of 30 wt % to 60 wt % in the organic-inorganic hybrid composition. According to an embodiment, the dispersion solvent may be included in an amount of 30 wt % or greater, 40 wt % or greater, or 50 wt % or greater; 60 wt % or less, 50 wt % or less, or 40 wt % or less, or may be included in a range between two values selected from the aforementioned values.

According to an embodiment, the refractive index of the organic-inorganic hybrid composition may be in a range of 1.50 to 1.80.

According to an embodiment, the organic-inorganic hybrid composition may be a dispersion composition having a high refractive index, and may have a refractive index of 1.50 or greater, 1.55 or greater, 1.60 or greater, 1.65 or greater, 1.70 or greater, or 1.75 or greater; or 1.80 or less, 1.75 or less, 1.70 or less, 1.65 or less, 1.60 or less, 1.55 or less; or in a range between two values selected from the aforementioned values.

According to an embodiment, the viscosity of the organic-inorganic hybrid composition may be in a range of 180 cPs to 20,000 cPs (based on 25° C.). According to an embodiment, the viscosity of the organic-inorganic hybrid composition may be adjusted using a viscosity modifier such as MEK, toluene, or ethyl acetate. According to an embodiment, the viscosity of the organic-inorganic hybrid composition may desirably be in a range of 180 cPs to 10,000 cPs (based on 25° C.) and more desirably be in a range of 180 cPs to 1,000 cPs (based on 25° C.).

According to an embodiment, the haze value of the organic-inorganic hybrid composition may be less than or equal to 15%.

According to an embodiment, the haze value of the organic-inorganic hybrid composition may be 15% or less, desirably 14% or less, and more desirably 6% or less.

The adhesive film according to an embodiment may be prepared using the organic-inorganic hybrid composition. The adhesive film, as an organic-inorganic hybrid composition according to an embodiment, may include inorganic particles with surfaces modified by a surface treatment agent, and an acrylic monomer, and may be prepared using a compound having the inorganic particles and the acrylic monomer in a weight ratio of 1:1 to 2:1.

According to an embodiment, the adhesive film may include, for example, an optically clear adhesive (OCA) film or a pressure sensitive adhesive (PSA) film. An optically transparent adhesive film with flexibility may be provided.

Hereinafter, the present disclosure will be described in detail based on examples and comparative examples.

However, the following examples are only for illustrating the present disclosure, and the present disclosure is not limited to the following examples.

1. Preparation of Surface Treatment Agent

### Example 1-1

3-Methacryloxypropyltrimethoxysilane (MPTMS) and 2-hydroxyethyl methacrylate (2-HEMA) as monomers were mixed in a methyl ethyl ketone (MEK) solvent in a weight ratio of 1:1. 0.01 g of AIBN as a polymerization initiator was added. Here, the solvent was mixed in the same amount as a total weight of the monomers. The mixture was grown at 60° C. for 3 hours under a nitrogen atmosphere and then stirred at room temperature for 12 hours such that the monomers were polymerized, to obtain a polymer.

### Comparative Example 1-1

A polymer was obtained in the same manner as in Example 1-1, except that 2-hydroxyethyl acrylate (2-HEA) was used instead of 2-HEMA.

### Comparative Example 1-2

A polymer was obtained in the same manner as in Example 1-1, except that 2-hydroxybutyl acrylate (2-HBA) was used instead of 2-HEMA.

2. Preparation of Surface-Treated Inorganic Particle Dispersion Liquid

### Example 2-1

40 g of zirconia powder having an average particle diameter of 10 nm, 60 g of methyl ethyl ketone (MEK) as a dispersion solvent, and 20 parts by weight of the polymer of Example 1-1 as a surface treatment agent based on 100 parts by weight of the zirconia powder were added and dispersed for 3 hours, to prepare an inorganic particle dispersion liquid.

### Example 2-2

An inorganic particle dispersion liquid was prepared in the same manner as in Example 2-1, except that 30 parts by weight of the surface treatment agent were added with respect to 100 parts by weight of the zirconia powder.

### Example 2-3

An inorganic particle dispersion liquid was prepared in the same manner as in Example 2-1, except that 40 parts by weight of the surface treatment agent were added with respect to 100 parts by weight of the zirconia powder.

### Comparative Example 2-1

An inorganic particle dispersion liquid was prepared in the same manner as in Example 2-1, except that the polymer of Comparative Example 1-1 as a surface treatment agent was added.

### Comparative Example 2-2

An inorganic particle dispersion liquid was prepared in the same manner as in Comparative Example 2-1, except that 30 parts by weight of the surface treatment agent were added with respect to 100 parts by weight of the zirconia powder.

### Comparative Example 2-3

An inorganic particle dispersion liquid was prepared in the same manner as in Comparative Example 2-1, except that 40 parts by weight of the surface treatment agent were added with respect to 100 parts by weight of the zirconia powder.

### Comparative Example 2-4

An inorganic particle dispersion liquid was prepared in the same manner as in Example 2-1, except that the polymer of Comparative Example 1-2 as a surface treatment agent was added.

### Comparative Example 2-5

An inorganic particle dispersion liquid was prepared in the same manner as in Comparative Example 2-4, except that 30 parts by weight of the surface treatment agent were added with respect to 100 parts by weight of the zirconia powder.

### Comparative Example 2-6

An inorganic particle dispersion liquid was prepared in the same manner as in Comparative Example 2-4, except that 40 parts by weight of the surface treatment agent were added with respect to 100 parts by weight of the zirconia powder.

### Comparative Example 2-7

40 g of zirconia powder having an average particle diameter of 10 nm, 60 g of methyl ethyl ketone (MEK) as a dispersion solvent, and 10 parts by weight of methacryloxypropyltrimethoxysilane as a surface treatment agent based on 100 parts by weight of the zirconia powder were added and dispersed for 3 hours, to prepare an inorganic particle dispersion liquid.

### Comparative Example 2-8

An inorganic particle dispersion liquid was prepared in the same manner as in Comparative Example 2-7, except that 15 parts by weight of the surface treatment agent were added with respect to 100 parts by weight of the zirconia powder.

### Comparative Example 2-9

An inorganic particle dispersion liquid was prepared in the same manner as in Comparative Example 2-7, except that 20 parts by weight of the surface treatment agent were added with respect to 100 parts by weight of the zirconia powder.

### Experimental Example 1: Optical Properties of Inorganic Particle Dispersion Liquid

To confirm optical properties of the inorganic particle dispersion liquid according to Examples 2-1 to 2-3 and Comparative Examples 2-1 to 2-9, a total light transmittance and haze were measured and shown in Table 1 below.

TABLE 1

| | Light | | |
|---|---|---|---|
| Category | transmittance (%) | Haze (%) | Yield (%) |
| Example 2-1 | 40.77 | 48.25 | 97 |
| Example 2-2 | 40.43 | 48.70 | 98 |
| Example 2-3 | 58.41 | 23.45 | 97 |
| Comparative | Solid phase (Recovery impossible) | | |
| Example 2-1 | | | |
| Comparative | 24.55 | 82.41 | 92 |
| Example 2-2 | | | |
| Comparative | 23.42 | 85.74 | 96 |
| Example 2-3 | | | |
| Comparative | Solid phase (Recovery impossible) | | |
| Example 2-4 | | | |
| Comparative | Solid phase (Recovery impossible) | | |
| Example 2-5 | | | |
| Comparative | 22.51 | 84.51 | 96 |
| Example 2-6 | | | |
| Comparative | Solid phase (Recovery impossible) | | |
| Example 2-7 | | | |
| Comparative | 17.38 | 92.79 | 97 |
| Example 2-8 | | | |
| Comparative | 15.95 | 92.80 | 97 |
| Example 2-9 | | | |

3. Preparation of Organic-Inorganic Hybrid Composition

### Example 3-1

50 wt % of methyl ethyl ketone (MEK) as a dispersion solvent, 40 wt % of zirconia powder having an average particle diameter of 10 nm, and 10 wt % of the polymer of Example 1-1 as a surface treatment agent based on the total composition were mixed, and the mixture was stirred for 30 minutes. Subsequently, 200 parts by weight of zirconia beads (with an average particle diameter of 0.05 mm) were added based on 100 parts by weight of the mixture so that zirconia particles may be uniformly dispersed, and the mixture was dispersed with a paint shaker for 3 hours, to recover a dispersion liquid. Based on 50 parts by weight of the prepared dispersion liquid, 45 parts by weight of butylacrylate as an acrylic monomer, and 5 parts by weight of a dispersant were added, and then the dispersion solvent was removed under a reduced pressure, to prepare a composition.

### Example 3-2

A composition was prepared in the same manner as in Example 3-1, except that 2-ethylhexyl acrylate as an acrylic monomer was added.

### Example 3-3

A composition was prepared in the same manner as in Example 3-1, except that isobornyl acrylate as an acrylic monomer was added.

### Example 3-4

A composition was prepared in the same manner as in Example 3-1, except that 4-acryloyl morpholine as an acrylic monomer was added.

### Comparative Example 3-1

A composition was prepared in the same manner as in Example 3-1, except that methacryloxypropyltrimethoxysilane as a surface treatment agent was added.

### Comparative Example 3-2

A composition was prepared in the same manner as in Comparative Example 3-1, except that 2-ethylhexyl acrylate as an acrylic monomer was added.

### Comparative Example 3-3

A composition was prepared in the same manner as in Comparative Example 3-1, except that isobornyl acrylate as an acrylic monomer was added.

### Comparative Example 3-4

A composition was prepared in the same manner as in Comparative Example 3-1, except that 4-acryloyl morpholine as an acrylic monomer was added.

### Experimental Example 2: Physical Properties of Organic-Inorganic Hybrid Composition

To confirm physical properties of the compositions of Examples 3-1 to 3-4 and Comparative Examples 3-1 to 3-4, a refractive index, a viscosity, and a haze value were measured and shown in Table 2 below.

TABLE 2

| Category | Refractive index | Viscosity (cPs) | Haze (%) |
|---|---|---|---|
| Example 3-1 | 1.57 | 230 | 12.2 |
| Example 3-2 | 1.57 | 180 | 11.8 |
| Example 3-3 | 1.55 | 250 | 13.5 |
| Example 3-4 | 1.56 | 195 | 12.5 |
| Comparative | 1.57 | 450 | 15.8 |
| Example 3-1 | | | |
| Comparative | 1.57 | 480 | 16.2 |
| Example 3-2 | | | |
| Comparative | 1.54 | 380 | 19.4 |
| Example 3-3 | | | |
| Comparative | 1.55 | 320 | 16.5 |
| Example 3-4 | | | |

While the embodiments are described, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents. Therefore, other implementations, other embodiments, and equivalents to the claims are also within the scope of the following claims.

What is claimed is:

1. A surface treatment agent for an organic-inorganic hybrid composition, the surface treatment agent comprising a compound represented by one of the following Chemical Formulae 1 to 3: 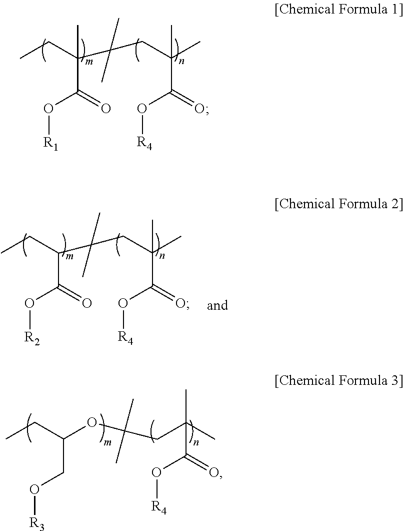
wherein R₁ to R₃ each comprise at least one of hydrogen (H), a saturated or unsaturated linear or branched C₁ to C₂₀ alkyl group, a silane group, a hydroxyl group, and an alkoxysilane group, and R₄ comprises H or a hydroxyl group.

2. The surface treatment agent of claim 1, wherein R₁ to R₃ each comprise at least one selected from a group consisting of a C₂ to C₁₂ alkyltrimethoxy silane group, a C₂ to C₁₂ alkyltriethoxy silane group, and a C₂ to C₁₂ alkyldimethoxyethoxy silane group.

3. The surface treatment agent of claim 1, wherein R₄ comprises at least one selected from a group consisting of H, a 2-hydroxyethyl group, a 3-hydroxypropyl group, and a 2-hydroxybutyl group.

4. The surface treatment agent of claim 1, wherein an integer ratio between m and n is in a range of 1:2 to 2:1.

5. The surface treatment agent of claim 1, further comprising:
a polymerization initiator comprising at least one selected from a group consisting of benzoyl peroxide (BPO), azobisisobutyronitrile (AIBN), and 2,2′-azobis(2-methylpropionamidine)dihydrochloride (AIBA).

6. The surface treatment agent of claim 5, wherein the polymerization initiator is in an amount of 0.1% by weight (wt %) to 1 wt % in the surface treatment agent.

7. The surface treatment agent of claim 1, wherein a light transmittance of the surface treatment agent is greater than or equal to 40%.

8. The surface treatment agent of claim 1, wherein a haze value of the surface treatment agent is less than or equal to 80%.
